(19) United States
(12) Patent Application Publication
(10) Pub. No.: US 2017/0200249 A1
(43) Pub. Date: Jul. 13, 2017

(54) SYSTEMS AND METHODS FOR INTELLIGENT, DEMAND-RESPONSIVE TRANSIT RECOMMENDATIONS

(71) Applicants: Oliver Ullrich, Miami Beach, FL (US); Naphtali David Rishe, Miami Beach, FL (US); Daniel Luckerath, Miami, FL (US)

(72) Inventors: Oliver Ullrich, Miami Beach, FL (US); Naphtali David Rishe, Miami Beach, FL (US); Daniel Luckerath, Miami, FL (US)

(73) Assignee: Florida International University Board of Trustees, Miami, FL (US)

(21) Appl. No.: 14/991,341

(22) Filed: Jan. 8, 2016

(51) Int. Cl. G06Q 50/30; H04L 29/08; G06Q 30/06

(52) U.S. Cl. CPC G06Q 50/30; G06Q 30/0631; H04L 67/18

(57) ABSTRACT

Techniques and systems are described that enable the intelligent recommendation and presentation of demand-responsive transit services. Implementations can analyze current user activities with respect to historically-based user transit behaviors in order to determine the user's imminent transit demands. Prior-scheduled transit options meeting the imminent demand are searched, and filtering parameters including user preferences and demand-responsive transit provider constraints are retrieved. Embodiments further retrieve possible demand-responsive transit options for meeting the demand from a demand-responsive transit system scheduling/information service. Embodiments consolidate and analyze these diverse sources to identify a set of preferred transit alternatives for available transit options that meet the filtering parameters. Implementations are described that integrate with an existing transit application present on a user device (e.g., a mobile device). Certain embodiments may include capabilities for surfacing an enhanced transit options view that shows an identified imminent transit demand and a selection of preferred transit alternatives.

### GOVERNMENT SUPPORT

This invention was made with government support under grant numbers I/UCRC IIP-1338922, AIR IIP-1237818, III-Large IIS-1213026, MRI CNS-1532061, CREST HRD-0833093 awarded by the National Science Foundation. The government has certain rights in the invention.

### BACKGROUND

Generally, a transit system is a large-scale public transportation system serving a given area, typically comprising buses, subways, and elevated trains. A transit system usually has numerous transit lines which represent pathways through the given area from a starting point to an ending point through various intermediate stopping points. One or more transit vehicles can service a particular transit line, generally several times a day.

Many travelers are creatures of habit, using the same transit modes and routes on the transit system every day to minimize the impact of unfamiliar surroundings and traveling modes. Therefore, it can be difficult to get users to adapt to new transit services, especially if those services are unfamiliar. Additionally, users may not realize that they sometimes make suboptimal travel decisions because they do not have access to the necessary information to analyze their behavioral travel patterns. Furthermore, even if they had access to this kind of information, they do not have the means to conveniently relate available transit services to their behavior patterns.

### BRIEF SUMMARY

While there exist transit recommendation services which help users make better transit decisions, (e.g., Google Now®), these services use only static information about traditional transit modes. Techniques and systems of the subject invention overcome these limitations by providing for intelligent recommendation of demand-responsive transit services.

A demand-responsive transit service (DRTS) is an advanced, user-oriented form of public transport characterized by flexible routing and scheduling of transit vehicles that operate in shared-ride mode between pick-up and drop-off locations in response to transit users' needs. DRTS may also be known as Demand Responsive Transport or Demand-Responsive Transit (DRT), or Flexible Transport Services. A DRTS, as described herein, can also include a transit service where most or all of the transport vehicles operate on a fixed path at fixed times, but where transport vehicles may deviate from the fixed routes, on demand, to collect or drop off passengers.

DRT services may be provided by a private company, government, or municipality in conjunction with a more general transit system or mass transit system. Traditionally, DRT systems provide a public transport service for areas of low passenger demand, such as rural areas, where a regular bus service would not be viable. DRT services may also be provided for disabled or elderly passengers. Such services may be used to more cost effectively serve passengers in low-demand areas or times, while preserving the overall social benefit of providing comprehensive public transport to citizens. Generally, a user of DRT must specifically request or schedule the service.

Demand responsive transit modes can include, for example, dedicated vehicles like taxis, multiple-hire taxis, roving buses, smart shuttles, and mini-buses that are dispatched to a specific location at a specific time. DRT modes can also include additional stops on the conventional route of a transit vehicle, as well as route changes or path deviations made from the conventional route of a transit vehicle.

Embodiments of the subject invention can analyze current user activities with respect to historically-based user transit behaviors in order to determine the user's imminent transit demands. Prior-scheduled transit options meeting the imminent demand are searched, and filtering parameters including user preferences and demand-responsive transit provider constraints are retrieved. Embodiments further retrieve possible demand-responsive transit options for meeting the demand from a demand-responsive transit system scheduling/information service. Embodiments consolidate and analyze these diverse sources to identify a set of preferred transit alternatives for available transit options that meet the filtering parameters. Advantageously, preferred transit alternatives may include demand-responsive transit options as an alternative to conventional transportation modes.

An imminent transit demand can include both deviations from the user's typical transit behaviors as well as potentially preferable transit alternatives to the user's typical transit modes and routes.

Some embodiments include techniques and systems for integrating with an existing transit application present on a user device (e.g., a mobile device). Certain embodiments may include capabilities for surfacing an enhanced transit options view that shows an identified imminent transit demand and a selection of preferred transit alternatives.

In some embodiments, the quality of the recommendations for preferred transit alternatives are further enhanced by techniques and systems for presenting, collecting, and utilizing positive and negative user feedback about the preferred transit alternatives.

Advantageously, in conjunction with a comprehensive transit information system, embodiments of the subject invention can widen the user base for existing demand-responsive transit systems and lower the threshold of user participation. Enhanced capabilities and user interface views for transit options can make composite and diverse information sets (e.g., transit user behavioral data, current transit user location data, transit options from both conventional and demand-responsive transit systems, transit provider constraints, and user preferences) usable by creating an improved user experience. Increased adoption of demand-responsive transit system capabilities can advantageously reduce the inefficiencies of a transit system, having a technical effect by improving energy efficiency and reducing the carbon footprint and/or emissions output of a municipality.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an example component environment in which a transit application may be enhanced with intelligent recommendations of demand-responsive transit services.

FIG. 2 describes a process perspective of certain techniques for providing intelligent recommendation of demand-responsive transit services.

FIG. 3A illustrates an example view of a transit application UI with demand-responsive transit options.

FIG. 3B shows an example of a UI with input elements for acceptance and/or rejection feedback.

FIG. 3C shows an example of a UI with input elements for adjusting user preferences.

FIG. 4 describes an example process flow for implementing intelligent recommendation of demand-responsive transit services.

FIG. 5 shows a block diagram illustrating components of a computing device or system used in some embodiments incorporating techniques and systems for intelligent recommendation of demand-responsive transit services.

### DETAILED DESCRIPTION

Techniques and systems are described that enable the intelligent recommendation and presentation of demand-responsive transit services. Presented below is a detailed description of embodiments of the techniques and systems of subject invention, including numerous illustrative example scenarios.

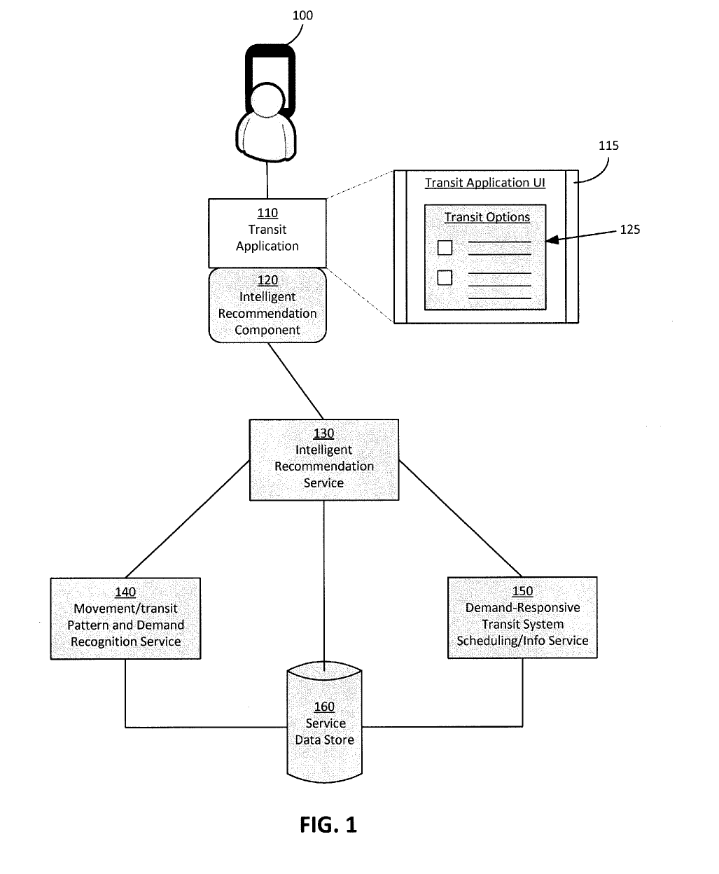

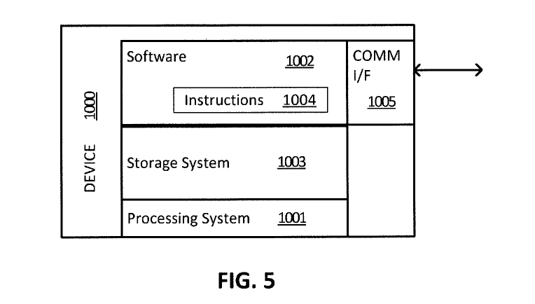

FIG. 1 shows an example component environment in which a transit application may be enhanced with intelligent recommendations of demand-responsive transit services. In FIG. 1, a transit user interacting with a mobile device 100 (e.g., a smartphone) is shown. The mobile device 100 can be, for example, a type of device/system 1000 as described in relation to FIG. 5. The mobile device 100 may provide a transit user the opportunity to get transit information, such as bus/train schedules or real-time updates regarding delays, for example, via a transit application 110 accessible through the mobile device 100.

A “transit application” refers to a software program that enables a transit user to navigate a transit system or mass transit system, such as might be found in major urban or suburban areas. A transit application can be provided by the operator of the transit system, such as a city or county, or may be provided by a third party that offers the information as part of a free or paid service. The transit application can be, for example, a dedicated application that provides only or predominantly transit system information, or could be an information service integrated into a more generalized wayfinding application or service (e.g., Google Now®). Naturally, a transit application can be found on a wide variety of devices and/or form factors (e.g., phones, tablets, laptops, wearables), therefore its presentation on a mobile device in this example component environment is not intended to be limiting.

Transit application 110 may display a transit application user interface (UI) 115 containing transit information and UI elements that allow the transit user to interact with the device and, e.g., make transit option selections or input transit preferences.

Generally speaking, techniques and systems for intelligent recommendation of demand-responsive transit services may be implemented such that capabilities present on a transit user device, e.g., a mobile device 100, work in concert with one or more services hosted on “cloud” or remote servers. For example, local components (e.g., an intelligent recommendation component 120) on a user device 100 provide the capability to gather transit-user-related historical and real-time location information and communicate with cloud services (e.g., 130, 140, and 150) to obtain transit option recommendations.

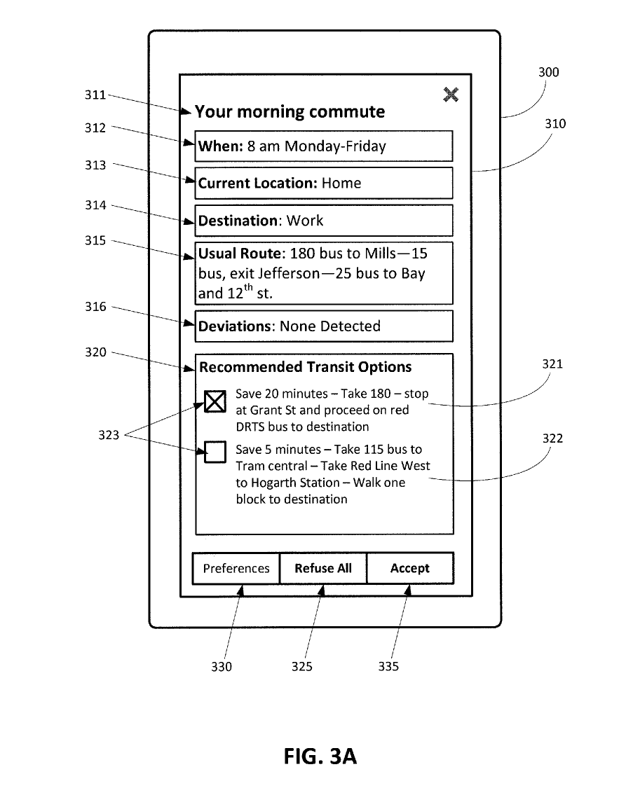

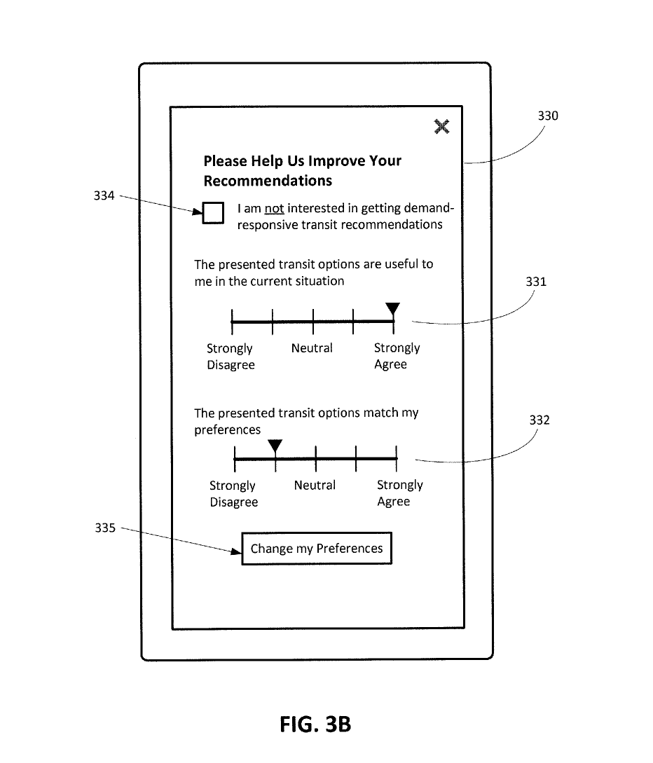

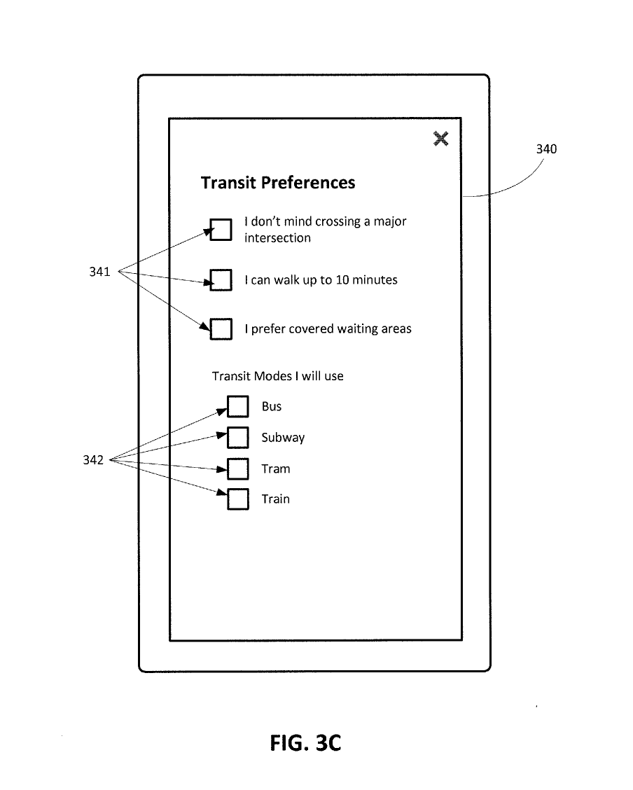

Sometimes, an intelligent recommendation component 120 can facilitate the interaction between cloud services/information sources (e.g., 130, 140, and 150) and the transit application 110 to provide and display demand-responsive transit options to the transit user. Demand-responsive transit options may be displayed, for example, as transit options view 125 within the UI of a transit application 115. Specific examples of a transit options interface 125 are shown in FIGS. 3A-3C.

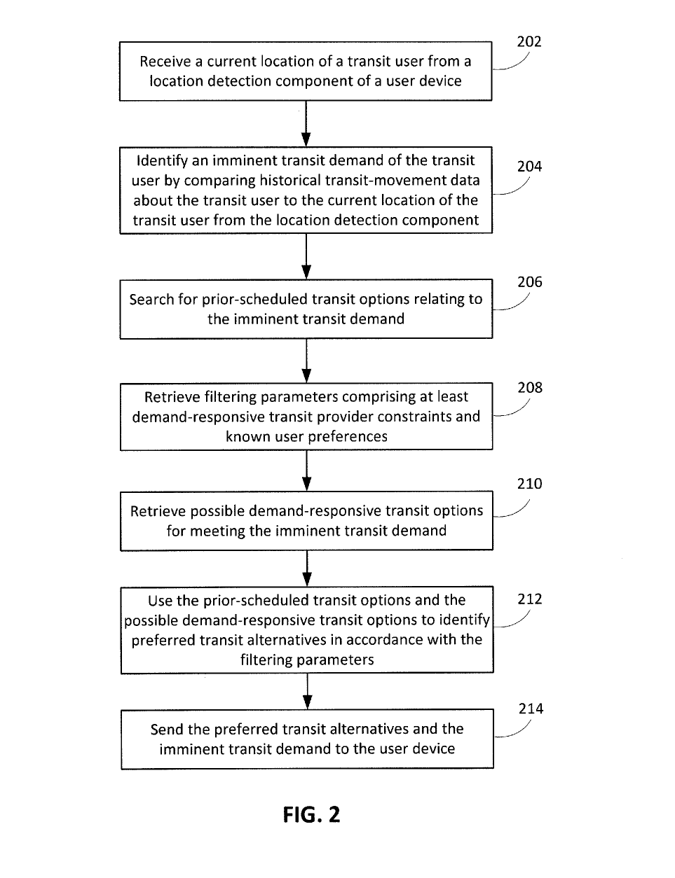

In some cases, the intelligent recommendation component 120 accesses or interacts with a remote or cloud service counterpart, e.g., an intelligent recommendation service 130. Intelligent recommendation service 130 may receive requests and user device data from intelligent recommendation component 120, as well as implement process flows as described, for instance, in FIG. 2. Intelligent recommendation service 130 may interact, in some embodiments, with other cloud services or information services, such as movement/transit pattern and demand recognition service 140 and/or demand-responsive transit system scheduling/information service 150.

Intelligent recommendation service 130 may sometimes store information in a service data store 160. In some instances, the data store 160 can contain data structures for storing data, metadata, and/or properties relating to the constraints and preferences of individual transit users. For instance, a transit user may indicate certain preferences about their own transit use by interacting with the transit application to select options or ranges that assist the recommendation service 130 in making informed and accurate recommendations. Examples of such stored preferences can include an individual user's indicated trade-off between travel time, available budget, and personal convenience; a transit user's willingness to walk for short intervals; a preference for covered and/or climate-controlled waiting areas; and the maximum number of transfers the user is willing to make.

In some cases, the service data store 160 can include historical data, for example, about a user's discrete movements, transit behaviors, or transit habits. The data in the data store might reflect a historical record of real-time data obtained from other components (e.g., movement/transit pattern and demand recognition service 140) or from other sources. Any or all of this historical data may be used to predict or estimate, e.g., passenger behaviors or preferences.

The intelligent recommendation service 130 may read information persisted on the data store 160 and in some implementations update information on the data store 160 to update the state of the system. Furthermore, examples of data, metadata, and properties are not intended to limit the amount or varieties of data that may be stored by the data store 160. Data store 160 may be implemented as databases, tables, and records in a database management system or relational database management system, examples of which are Microsoft SQL Server® and Oracle®. Data store 160 may also be implemented using NoSQL techniques, XML file structures, or other file structures, as will be appreciated by practitioners in the art.

In certain embodiments, a movement/transit pattern and demand recognition service 140 can store, retrieve, identify, and predict the habits and transit patterns of a transit user, as well as determine deviations from typical transit behavioral patterns.

In some cases, for example, an intelligent recommendation component 120 accesses the location detection component (e.g., a GPS transceiver) of a mobile device 100 to obtain current location information about a transit user. Intelligent recommendation component 120 can then periodically transmit the user location information to the movement/transit pattern and demand recognition service 140 (in FIG. 1, via the intelligent recommendation service 130), which stores the information as historical transit-movement data. Transmission of the transit user's current location may occur, for example, on a periodic, timed schedule (e.g., every minute) or when the GPS indicates that the transit user is near a transit-relevant location such as a bus stop or subway station.

The movement/transit pattern and demand recognition service 140 may store a historical record of transit-movement data for individual transit users in the service data store 160. The stored transit-movement data can include, for example, transit user locations determined from a GPS device on the mobile device, proximity to or presence in transit-relevant locations such as a bus stop, subway station, or on a specific subway line or bus at a certain time, as well as a history of selected transit options on the transit application, and records of actual usage of transit services. Historical transit-movement data can also include transactional records from prior passenger activities, such as ticket purchases. Other historical transit-movement data can include, for example, start time/location of a journey; end time/location of a journey; times and frequencies of usage; utilized transit modes, routes, and services; and intermediate stops, transfers, and transportation mode changes.

Building a repository of historical transit-movement data may enable the movement/transit pattern and demand recognition service 140 to recognize a transit user's typical behavioral habits. By analyzing historical location data, movement/transit pattern and demand recognition service 140 may be able to determine, for example, that a transit user travels to and from work every weekday at a certain time using certain transportation modes. Over time, even very specific, unique, or occasional transit patterns may be determined, for example, that a transit user works from home every Monday.

By understanding an individual user's typical transit behaviors, movement/transit pattern and demand recognition service 140 can identify deviations from the user's typical transit and movement patterns. In one scenario, for instance, the intelligent recommendation component 120 can access the device GPS to provide location updates to the intelligent recommendation service 130. With the current location of the transit user, the intelligent recommendation service 130 can access the movement/transit pattern and demand recognition service 140 to determine whether the transit user is adhering to his or her usual transit pattern or has deviated in some way, for example, by shifting start times, shifting locations, or changing transit modes, routes, or services.

If the transit user has deviated from the usual transit pattern, the movement/transit pattern and demand recognition service 140 can inform the intelligent recommendation service 130 that the transit user has an imminent transit demand. The intelligent recommendation service 130 may then use the service data store 160, transit information sources, and/or a demand-responsive transit system scheduling/info service 150 to determine the recommended transit options to suggest to the user via a transit application UI 115, for example, on a transit options view 125.

In some cases, the transit user can receive recommended transit options while on his or her normal transit pattern. For example, movement/transit pattern and demand recognition service 140 may inform the intelligent recommendation service 130 that the transit user has an imminent transit demand indicating a typical movement/transit pattern is being followed. The intelligent recommendation service 130 may then recommend transit options to the transit user as described previously, that can be displayed in a transit options view 125 on the application 110.

As previously noted, intelligent recommendation component 120 may periodically update the intelligent recommendation service 130 with location information. This location information may be transmitted to the movement/transit pattern and demand recognition service 140 for multiple purposes, e.g., the location data may be used both to build a record of historical location data and to identify an imminent transit demand.

A demand-responsive transit system scheduling/info service 150 provides information systems and scheduling for a demand-responsive transit system, for example, to an intelligent recommendation service 130. A demand-responsive transit system scheduling/info service 150 can employ algorithms to automatically and dynamically route public short-distance transit to meet transit users' changing transit demands. The demand-responsive transit system scheduling/info service 150 can provide information about available options for rerouting transit (e.g., which buses can make additional or exceptional transit stops to meet a transit demand); provide information about previously arranged demand-responsive transit activities (e.g., a bus that has already been scheduled to make an additional demand-responsive stop); and provide mechanisms (e.g., APIs accessible to the intelligent recommendation service 130) for scheduling a new demand-responsive transit request at the transit service.

A demand-responsive transit system scheduling/info service 150 may have the capability, for example, to bundle user transit requests into shareable request clusters by analyzing numerous requests across the transit system and determining which requests can efficiently be served together by a single vehicle. The demand-responsive transit system scheduling/info service 150 may also analyze shareable request clusters to assemble rotations serviceable by single vehicles, as well as allocate and dispatch the actual vehicles to the assembled rotations.

It should be noted that the example of FIG. 1 illustrates one possible component architecture for implementing techniques and systems of the subject invention. Others may be possible, e.g., the intelligent recommendation component 120 may communicate directly with movement/transit pattern and demand recognition service 140 and demand-responsive transit system scheduling/info service 150 in some implementations. Depending on the implementation, for example, the intelligent recommendation component 120 may be integrated with a transit application or provided as a separate service accessible to the transit application.

While FIG. 1 represents a component and systems perspective on the subject invention, FIG. 2 describes a process perspective of certain techniques for providing intelligent recommendation of demand-responsive transit services. Activities described by the process flow may be performed, for example, by an intelligent recommendation component 120 and/or intelligent recommendation service 130, and by or in concert with a movement/transit pattern and demand recognition service 140, and/or demand-responsive transit system scheduling/info service 150.

Initially, a current location of a transit user from a location detection component of a user device can be received (202), for example, by an intelligent recommendation service 130. As described, a location detection component can be, for example, a GPS capability on the transit user's mobile device, or a registration device present on entryways of buses, trains, or transit stations that detect a broadcast signal of the user's device (e.g., a Bluetooth Low-Energy emanation, where the user has permitted the transit application to broadcast its presence in the transit system).

The current location of the transit user, to a varying degree of granularity, can be obtained from the location detection component, for example, at the instruction of the transit application 110 or an intelligent recommendation component 130. The application 110 or component 130 can interact with hardware components such as GPS or Bluetooth using native or lower-level calls, or it may interact with such hardware components through operating system (OS) provided capabilities. For example, on the Google Android® OS, “apps” or other components can take advantage of OS-provided application programming interface (API) functions to obtain the device's location, with user assent to use such functions.

The current location can be transmitted to the intelligent recommendation service 130 (or, in some implementations, directly to the movement/transit pattern and demand recognition service 140) based on the happening of an event (e.g., triggering a registration device upon entering a transit station) or periodically. A periodic transmitting of the current location can be, for example, every few minutes or seconds. In some cases, the periodic transmitting of the current location may be on a very short interval and measurable in partial seconds.

On receipt of the current location by a service (such as the intelligent recommendation service 130 or demand recognition service 140) an imminent transit demand of the transit user can be identified by comparing historical transit-movement data about the transit user to the current location of the transit user from the location detection component (204).

Identification of an imminent transit demand can be performed, for example, by a movement/transit pattern and demand recognition service 140. Over time, such a service 140 may collect information about the user's transit movements and store them as historical transit-movement data. At least some of the behavioral information collected can include the “current location” updates provided from a location detection component. The historical data used to determine transit habits can also incorporate transit usage information obtained from transit applications (e.g., search results, ticket purchases, or usage logs within the application), or from transit system devices (e.g., the “swipe” of the user's monthly fare card on entering a bus). Transit usage information can include, for example: start time and location of a journey; end time and location of a journey; and the transit modes and transit routes used throughout the journey, including intermediate stops, transfers, and transit mode changes.

The transit usage information may be utilized by the movement/transit pattern and demand recognition service 140 and, over time, can enable the service to recognize identifiable transit habit behavioral patterns. Such a service may employ data mining algorithms, AI training, etc., to identify user behavioral habits. For example, after a short time that a person uses a movement/transit pattern and demand recognition service 140 (e.g., two weeks), the service may be able to identify that a transit user travels to work every weekday at 8 AM and returns from work at 5 PM using particular transit modes and routes.

Recognizing this, the service can establish or identify a “normal” transit behavior. The current location can be used to confirm the normal behavior and, in some cases, may identify that a deviation from the user's normal/usual transit and movement patterns has occurred. Confirming a normal transit behavior or identifying a deviation from the normal behavior can be used to predict imminent transit demand by the transit user. For example, if a transit user is near his usual starting bus stop at the typical starting time on a weekday, then service 140 can conclude that the user is acting in accordance with his normal transit behavior and predict that the imminent transit demand maps to the user's normal pattern for commuting to work at that time. As an alternative example, if the current location reveals that the user is near the usual starting bus stop an hour earlier than is typical, then the user may be acting as usual with respect to his destination (e.g., work), but is deviating from the normal route by shifting the start time. This shifted start time may be important to intelligent recommendation because different transit options may be available at the altered time (e.g., more options, fewer options, express options, etc.).

Embodiments utilizing a movement/transit pattern and demand recognition service 140 to identify transit demands from behavioral data may be implemented in a variety of ways. In one type of implementation, for instance, current location information, along with a timestamp and unique user identifier (e.g. associated with the transit application or mobile device), may be stored in a service data store (e.g., 160) each time the current location is received from the transit application 110 or intelligent recommendation component 120. In some cases, pattern recognition algorithms, pattern matching algorithms, data mining algorithms, and artificial neural networks may be used to predict future locations from a current location. For example, sequential learning models such as Hidden Markov Models or Conditional Random Fields may be used.

In some embodiments, all or portions of a movement/transit pattern and demand recognition service 140 can be provided by a third-party service, such as Google® Now or Microsoft Cortana®. Transit application 110 or intelligent recommendation service 130 might interact with such a third-party service, for example via APIs, to receive predictive behavioral information that assists in understanding user transit behaviors.

Intelligent recommendation service 130, as well as other services or components described herein, may communicate with other devices, external or internal components, and system components in some cases using an application programming interface (API). An API is generally a set of programming instructions and standards for enabling two or more applications to communicate with each other. An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API and related components may be stored in one or more computer readable storage media. An API is commonly implemented as a set of Hypertext Transfer Protocol (HTTP) request messages and a specified format or structure for response messages according to a REST (Representational state transfer) or SOAP (Simple Object Access Protocol) architecture.

When an imminent transit demand has been identified and transmitted, for example, to the intelligent recommendation service 130, the service can search for prior-scheduled transit options relating to the imminent transit demand (206). Prior-scheduled transit options include conventional fixed-route options, such as the transit system's typical routes, stops, and timetables. In some cases, prior-scheduled transit options can include prior-scheduled demand-responsive options. For example, if one transit user has already scheduled a demand-responsive option, such as by requesting an extra stop by a bus on an existing route, a second user may benefit by employing the same, prior-scheduled transit option.

The prior-scheduled transit options can be stored, for instance, in the service data store 160. For example, the service data store can hold a repository of the known fixed-route options, including their schedules, planned routes, and modes. The service data store can also hold a repository of previously-scheduled demand-responsive options that were recommended and accepted by other transit users of the system/service.

In some cases, prior-scheduled transit options can be obtained by connecting with and searching other data stores and/or services, for example, the transit system's operational databases or an information service that contains transit information such as Google Maps or Google Now. Search functions of this nature may be enabled by the outside data store or service via an accessible API. In some cases, the data store of a demand-responsive transit system scheduling/info service may be searched for previously-scheduled demand-responsive options.

Filtering parameters comprising at least demand-responsive transit provider constraints and known user preferences can be retrieved, for example, from the service data store (208) by the intelligent recommendation service 130. Any or all of these filtering parameters may be factors in determining the possible options for meeting the imminent transit demand.

Demand-responsive transit provider constraints include operational constraints of the transit service provider. For example, a transit provider may have a particular number of seats available on a given type of vehicle; the provider may receive a particular governmental subsidy for a demand-responsive trip; or a given vehicle may have certain capability limitations (e.g., no bike rack). These operational constraints may determine whether a particular vehicle is capable of being employed to provide a demand-responsive transit option. For example, if a transit user requires a transit vehicle with a bike rack, then scheduling an additional stop by a nearby bus lacking a bike rack might not be able to satisfactorily provide the user with a demand-responsive option.

User preferences can include options, constraints, feedback, and configurable optimization trade-offs. In certain cases, interface elements of a transit application may provide a mechanism for a transit user to actively indicate selected preferences. A user can, for example, select a number or range of times that she is willing to transfer from one transit vehicle to another, indicate a willingness to walk for certain distances or lengths of time, a willingness to cross major intersections to another transit stop, a willingness to walk between intermediate stops, preferred transit modes (e.g., bus, subway, tram, train), and/or the types of amenities a transit station might have (e.g., covered, climate-controlled, with restrooms, etc.). In some cases, a transit user may configure an optimization trade-off, for example, to establish a weighting function between travel time, available budget, and personal convenience. Thus, when the intelligent recommendation service determines available demand-responsive transit options, it may optimize or sort the available options with a weighting toward the transit user's selected trade-offs. In some cases, a survey or feedback form may be presented to the user to obtain preferences from the user. When a user accepts or declines presented transit options, for instance, the intelligent recommendation service 130 may, in coordination with the intelligent recommendation component 120 and/or transit application 110, display general or targeted questions for gathering reasons for the acceptance or refusal. Examples of such interface elements are shown in FIGS. 3B-3C. It should be noted that these are only examples of the many kinds of transit user preferences that may be gathered and employed in techniques herein.

In some cases, behavioral data gathered about the user can be used to establish or refine preferences automatically. When a user selects a particular transit option, for instance, characteristics of the transit option may be used to predict the user's future preferences. For example, a transit user typically takes a commuting route that takes 45 minutes and includes 2 stops; if the intelligent recommendation service presents a transit option to the user that takes 30 minutes but includes 3 stops, and the user adopts that route on subsequent days, it may be established that the user prefers a less time-consuming route over the convenience of fewer intermediate stops. A variety of techniques may be used to refine or determine a user's preferences from behavioral data (e.g., Genetic Algorithms).

Possible demand-responsive transit options for meeting the imminent transit demand are retrieved (210), for example, in coordination with a demand-responsive transit system scheduling/info service 150. As noted, a demand-responsive transit system scheduling/info service 150 provides information systems and scheduling for a demand-responsive transit system. A demand-responsive transit system scheduling/info service 150 can employ algorithms to automatically and dynamically route public short-distance transit to meet transit users' changing transit demands. The demand-responsive transit system scheduling/info service 150 can provide information about available options for rerouting transit (e.g., which buses can make additional or exceptional transit stops to meet a transit demand); provide information about previously arranged demand-responsive transit activities (e.g., a bus that has already been schedule to make an additional demand-responsive stop); and provide mechanisms (e.g., APIs accessible to the intelligent recommendation service 130) for scheduling a new demand-responsive transit request at the transit service.

Retrieving possible demand-responsive transit options can be performed, for example, by the intelligent recommendation service 130, which communicates with the demand-responsive transit system scheduling/info service 150 using an accessible API of the service 150. The request might contain the start time/location and destination location (and a desired time frame or “arrival before” time), and/or one or more intermediate portions of a transit route. The intelligent recommendation service 130 may receive back from the demand-responsive transit system scheduling/info service 150 information about available transit system constraints or available demand-responsive transit options pertaining to start, destination, and intermediate waypoint times and locations.

The prior-scheduled transit options and the possible demand-responsive transit options can be used to identify preferred transit alternatives in accordance with the filtering parameters (212). For example, the intelligent recommendation service 130 may determine, by consolidating information regarding existing fixed route transit, previously arranged demand-responsive transit activities, possible demand-responsive transit options, and transit provider constraints, that one or more possible transit options exist to meet the imminent transit demand within a satisfaction range with respect to user preferences.

After identifying the preferred transit alternative, the preferred transit alternatives and the imminent transit demand are sent to the user device (214) for presentation, for example, by the transit application 110 and/or intelligent recommendation component 120.

An extended example scenario may illustrate the use and consolidation of this information by the intelligent recommendation service 130. Suppose, for example, that a transit user needs to arrive at work an hour earlier in order to be at an early meeting. The service determines this imminent transit demand by comparing the user's current location (e.g., nearing his usual bus stop) to his typical historical-transit movement data. Unbeknownst to the transit user, the first bus from that stop is the user's usual bus, i.e., no buses run from the bus stop at this hour on Fridays. The intelligent recommendation service 130 determines this fact from a search of the prior-scheduled transit options.

The intelligent recommendation service 130 retrieves transit provider constraints and known user preferences and determines that the transit provider receives a subsidy from the local government of $3 per passenger for providing demand-responsive transit, but the transit operator requires $6 to justify sending a dedicated transit vehicle to the bus stop. The intelligent recommendation service 130 also retrieves user preferences indicating that the transit user prefers sheltered transit stops and is willing to pay an extra fare in some cases.

The intelligent recommendation service 130 retrieves possible demand-responsive transit options for meeting the demand from the demand-responsive transit system scheduling/info service 150. No bus in the area is available to make an extra stop, therefore a dedicated transit vehicle will have to be dispatched to the stop to meet the demand. However, the $3 subsidy is not enough to justify the cost of the dedicated transit vehicle. Therefore, the transit user will have to agree to pay the extra fare before the dedicated transit vehicle is dispatched.

Meanwhile, a second transit user is approaching the same bus stop. The second transit user also needs to leave earlier than her normal commute time and also does not know that no earlier scheduled bus will be arriving. As the second user approaches the stop, the intelligent recommendation service 130 offers the dedicated transit vehicle to both transit users, who accept the offer. A request is sent by the intelligent recommendation service 130 to schedule the dedicated transit vehicle to pick up the passengers within 10 minutes and drop them off at a stop for the 185 bus, which takes both passengers to a central station where they can take their final buses to their destinations. Since a second, covered shelter is available only a short distance away from the first available stop for the 185 bus, the dedicated transit vehicle will drop both passengers at the covered shelter to wait for the arrival of the 185 bus.

In some cases, instead of offering transit alternatives related to a deviation in the user's normal transit habits, an imminent transit demand may enable the service to offer transit alternatives that better fit the user's preferences (e.g., shorter commute time). For example, the intelligent recommendation service 130 may determine from an imminent transit demand that the transit user can save 20 minutes off her commute time by utilizing a demand-responsive transit option and catching a different intermediate bus to her destination on Mondays and Fridays.

Some embodiments include feedback parameters and/or input elements for gathering additional feedback from the transit user provided in response to a selection or rejection of preferred transit alternatives by the user at the user device. The results of the additional feedback may be stored in the service data store as filtering parameters (e.g., user preferences) that may be incorporated into later determinations of preferred transit alternatives and/or imminent transit demands.

For instance, when an intelligent recommendation service 130 receives a negative indication that the user rejects all of the preferred transit alternatives that have been offered, the intelligent recommendation service 130 can provide negative feedback parameters and/or input elements for receiving rejection feedback from the user. The input elements can be displayed, for example, in the transit application UI 115 by a transit application 110 or in concert with an intelligent recommendation component 120. The input elements may be used to receive additional feedback pertaining to the reasons the transit user rejected the preferred transit alternatives. The intelligent recommendation service 130 can store the result of the negative indication (e.g., that the user declined several specific transit alternatives, which might be an indicator that the user does not prefer certain transit routes) and, when applicable, store the rejection feedback in the service data store.

When the intelligent recommendation service 130 receives a positive indication that the user accepts one of the preferred transit alternatives that have been offered, the intelligent recommendation service 130 can provide positive feedback parameters and/or input elements for receiving acceptance feedback from the user. The input elements can be displayed, for example, in the transit application UI 115 by a transit application 110 or in concert with an intelligent recommendation component 120. The input elements may be used to receive additional feedback pertaining to the reasons the transit user accepted the preferred transit alternative, and/or pertaining to ways the service might improve its recommendations in the future. The intelligent recommendation service 130 can store the result of the positive indication (e.g., that the user accepted a specific transit alternative, which might be an indicator that the user finds certain transit routes or modes agreeable) and, when applicable, store the acceptance feedback in the service data store.

Input elements for acceptance and/or rejection feedback may take various forms, including yes/no questions, checkboxes, sliding scales, option buttons, voice commands, etc. Input elements may be targeted toward the specific user and/or associated with the specific preferred transit alternatives being offered. In some cases, input elements may be of a more general character (i.e., applicable to a range of users or all users). FIG. 3B shows examples of input elements for acceptance and/or rejection feedback.

In certain embodiments, the intelligent recommendation service 130 facilitates the scheduling of a demand-responsive transit option when the transit user has assented to a preferred transit alternative that includes a demand-responsive transit option. When a positive indication that the user accepts one of the preferred transit alternatives has occurred and the positive indication includes one of the possible demand-responsive transit options, a transit scheduling request can be sent to a demand-responsive transit system. This may be performed, for example, by communicating with the demand-responsive transit system scheduling/info service 150 using an available API for scheduling.

FIG. 3A illustrates an example view of a transit application UI with demand-responsive transit options. For clarity, particular information showing an example scenario is included. It should be noted, however, that this particular example of a transit option interface is for illustrative purposes only and is not intended to be limiting; many other configurations of a demand-responsive transit option view are envisioned.

In the example in FIG. 3A, a transit user is using a transit application (e.g., 110) on a device 300. One aspect of the user interface provided by the transit application is a view 310 presenting an imminent transit demand identified from the current location of the transit user in reference to historical transit-movement behaviors. The view 310 may be spawned, for example, by an intelligent recommendation component 120 when current location prompts an information movement/transit pattern and demand recognition service 140 to identify that a transit user is deviating from (or following) a normal transit pattern.

Basic transit demand information, such as a transit pattern name 311 (“your morning commute”), the usual time range of the transit pattern 312 (“8 am Monday-Friday”), the current location 313 of the transit user (“home”), and the expected destination 314 (“work”) can be viewed. The usual route 315 (“180 bus to Mills 15 bus, exit Jefferson-25 bus to Bay and 12th St.”) may also be displayed. The view 310 may also indicate whether deviations 316 (“none detected”) from a normal transit pattern have been identified by the movement/transit pattern and demand recognition service 140. In some implementations, e.g., in devices with smaller form factors, relevant basic transit demand information may surface in response to a particular command.

View 310 also provides information associated with preferred transit alternatives 320 (e.g., “recommended transit options”) as determined by, e.g., an intelligent recommendation service 130. Depending on the particular circumstances of the imminent transit demand, the preferred transit alternatives may relate to a deviation from a normal transit pattern or a potentially more efficient or preferable set of transit alternatives for a normal transit demand. In the example of FIG. 3A, the preferred set of transit alternatives (321, 322) are offered to save a transit user time over her normal transit route for the morning commute. The transit alternatives listed in the interface element may be constructed, as described with respect to FIG. 2, from existing transit routes and from prior-scheduled and potential demand-responsive transit options.

Also included in some implementations is an interface element 323 for receiving an indication from the transit user to select and utilize one of the preferred transit alternatives. In one case, if one of the preferred transit alternatives is selected, the user can select an interface element to indicate acceptance of the chosen transit alternative (e.g., “Accept” button 335). A clearer view of the new transit route for the chosen alternative may sometimes be displayed. Furthermore, the indication may be sent back to the intelligent recommendation service, which can then schedule any needed events by sending a request to the demand-responsive transit system.

Certain implementations include a user interface with associated input elements for gathering additional feedback from the transit user provided in response to a selection or rejection of preferred transit alternatives by the user at the user device. FIG. 3B shows an example of a UI with input elements for acceptance and/or rejection feedback.

As shown in FIG. 3B, for example, the service can provide a series of questions or user prompts to the user on which the user can indicate his or her feedback on the usefulness of the transit recommendations. The input elements, collectively shown as UI 330, can be displayed, for example, in the transit application UI 115 by a transit application 110 and/or intelligent recommendation component 120. Input elements may be customized to the particular response of the user (e.g., acceptance or rejection), as well as customized to the particular user or particular transit scenario. For example, a user may be able to indicate whether the currently offered transit options are useful to the user (e.g., 331), and the response by the user may be stored in the service data store in association with the particular transit recommendations in order to build behavioral data. In some cases, the user may be asked, for example, if the presented options are an accurate reflection of the transit user's selected or perceived preferences (e.g., 332). The user may be presented an interface element allowing him or her to alter or refine the preferences (e.g., 335). User input elements to obtain more general feedback may also be displayed, such as whether the user is interested in receiving demand-responsive transit recommendations (e.g. 334).

As noted, certain implementations may allow the user to actively adjust user preferences that are factored into the service's identification of preferred transit alternatives. FIG. 3C shows an example of a UI with input elements for adjusting user preferences. The input elements, collectively shown as UI 340, can be displayed, for example, in the transit application UI 115 by a transit application 110 or intelligent recommendation component 120. For example, a user may be able to actively indicate personal preferences (e.g., 341), such as a willingness to cross intersections, ability to walk for a certain distance, or the desired kinds of transit stop facilities. The user may also be able to select preferred/non-preferred transit modes 342, such as bus, train, subway, and tram. Naturally, these examples of transit preferences are not intended to be limiting.

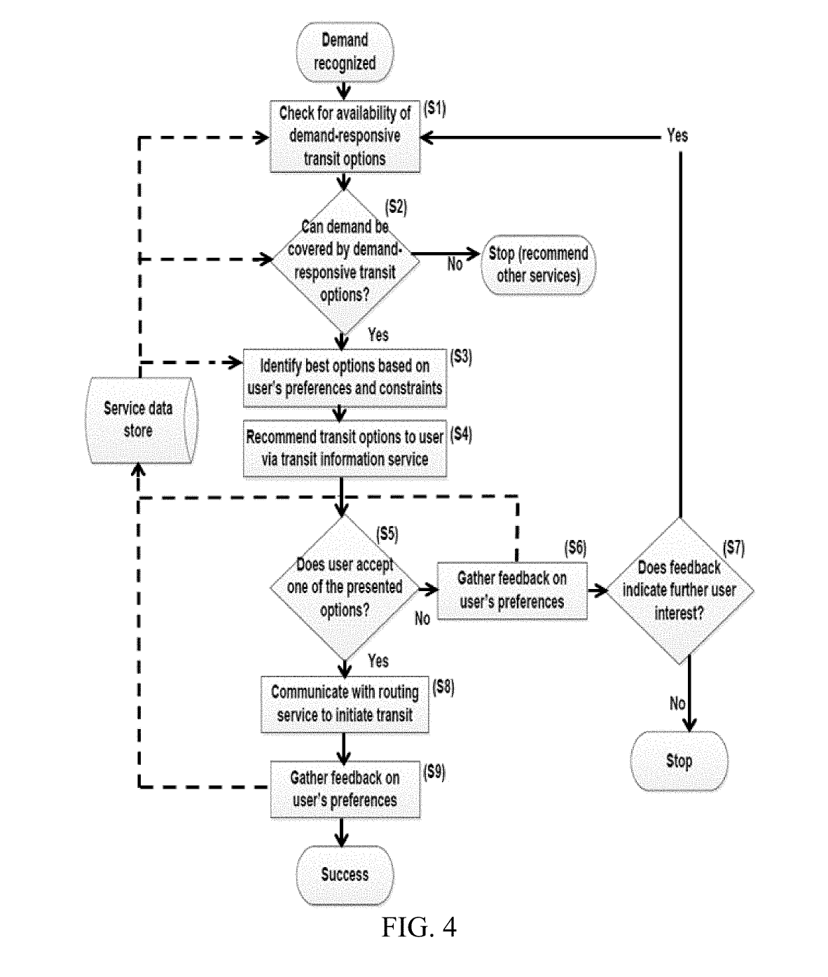

The example process flow of FIG. 2 presents activities related to certain embodiments of the subject invention. Another possible process flow, shown in FIG. 4, can be illustrative of other embodiments and may be performed, e.g., all or in part by an intelligent recommendation service 130.

(S1) Initially, the process flow can be activated by, e.g., a movement/transit pattern and demand recognition service 140 as it identifies a user's imminent transit demand. The intelligent recommendation service 130 identifies all potential transit options covering the user's imminent transit needs, as determined by the movement/transit pattern and demand recognition service 140. To this effect, the intelligent recommendation service 130 checks the recognized transit demand and the set of known user preferences against the data on available transit options and transit provider constraints provided by the demand-responsive transit system scheduling/info service 150.

(S2) If possible demand-responsive transit options matching the user's transit needs can be identified, the process continues with (S3). If no potential options exist, then the process flow is terminated or other recommendation services, if available, may be offered.

(S3) The process establishes an order on the set of potential transit options according to the user's known preferences and constraints, e.g., her trade-off between time, budget, and personal convenience. A number of these identified “preferred” transit options are prepared for presentation.

(S4) The user is notified via the transit application (e.g., on a smart-phone) that demand-responsive options are available which might fit the imminent transit demand and/or might supersede a usual mode of travel. The best fitting transit options are presented to the user utilizing the transit application. For convenience, the estimated best fit may be preselected. (S5) The user evaluates the preferred transit options and either selects one or rejects all presented options. The decision is saved to the service data store to refine the method's model of the user's preferences.

(S6) If the user rejected all the presented options, the intelligent recommendation service's 130 model of the user's preferences might be wrong or incomplete. To refine its model and thus to improve future transit recommendations, the process gathers rejection feedback by asking a few simple questions via the transit application UI, and saves the results to the service data store. The short survey might include questions of the following types:

a. Is the user generally interested in getting dynamic-responsive transit recommendations?

i. If so, are the presented options meaningful and useful to the user in the current situation? Does the user feel the presented options generally map to the user's set of preferences in the best possible fashion?

ii. If not, what are the user's preferences in transit modes? What are the user's preferences in transit stops and stations? What is the user's trade-off in travel time, budget, and personal convenience?

(S7) If the gathered feedback indicates that the user has no interest in further recommendations, the process flow terminates. Otherwise, the feedback is used to improve the stored information on the user's constraints and preferences, and the execution continues with step (S1), utilizing the now updated set of constraints and preferences.

(S8) If the user in (S5) selects one of the presented transit options, the process communicates this information to the demand-responsive transit service, which subsequently may alter the corresponding route by inserting new stops or by rerouting a vehicle to meet the user's request.

(S9) The process gathers acceptance feedback (e.g., as in (S6) above) from the user regarding her transit choice and saves it in the service data store to refine future transit recommendations.

Understanding of the functioning of certain embodiments of the subject invention may be enhanced by the following example scenarios. Examples may also illustrate advantages, including technical effects, of the disclosed techniques and systems. These example scenarios are illustrative and not intended to be limiting.

In a first example scenario, consider a user who always leaves her house at 8:00 a.m. on workdays to take the same transit mode and route to work from a nearby stop at 8:10 a.m. This journey usually takes her 50 minutes. For the first week of using embodiments of the subject invention, the movement/transit pattern and demand recognition service has gathered the required data about the user, stored it in the service data store, and refined its recognition algorithms.

On the next Monday at 7:45 a.m., the movement/transit pattern and demand recognition service has gathered enough data and recognizes the user's imminent transit need. It informs the intelligent recommendation service, which subsequently checks the service data store for already scheduled demand-responsive transit and also requests a custom-tailored transit offer from the demand-responsive transit system scheduling/info service.

The resulting set of potential transit options is ordered by the recommendation service, employing data about the user's constraints and preferences found in the service data store. Assessing this ordered set, the recommendation service finds that only the highest ranking option would meet the user's preference to an acceptable degree. This is an already scheduled demand-responsive transit option which could pick up the user at a point halfway on her typical first segment of the route and go directly to her destination without further detours. This would allow the user to arrive at the same time as usual but with a shorter traveling time of 30 minutes instead of 50, thus allowing for a later start.

The recommendation service immediately notifies the user and presents her with the potential transit option via the transit information application/service running on her smartphone. Seeing that she could save 20 minutes and still be at work on time, she accepts the offer. The recommendation service communicates this to the demand-responsive transit system scheduling/info service, which subsequently inserts a new stop in the already scheduled route. Simultaneously, the recommendation service asks the user for feedback on the transit recommendation which she happily provides. This information is saved in the service data store to further improve the knowledge about the user's preferences and subsequently improve future recommendations.

In a second example scenario, consider a user who usually leaves the house at 8:00 a.m. on workdays to take a bus from a nearby stop to a transportation hub at 8.15 a.m. He arrives there at 8:30 a.m. and transfers at 8:35 am to a tram which takes him the rest of the way to work, where he arrives at 9:00 am. He is content with this journey and not interested in changing his routine. The movement/transit pattern and demand recognition service already gathered the required data about the user, stored it in the service data store, and refined its recognition algorithms.

One Wednesday, the user has to take part in an important advisory board meeting and thus leaves his house an hour early at 7:00 a.m. At 7:15 a.m. the user enters the bus for the first leg of his journey. At 7:20 a.m. the movement/transit pattern and demand recognition service notices the temporal shift in the user's movement pattern and alerts the recommendation service about the potential transit need. The recommendation service checks for potential transit options and finds that the user will not be able to continue his journey without a significant delay at the transportation hub because the connecting tram service is not in operation until later in the morning. Instead, the recommendation service finds two suitable demand-responsive community bus offers which cover (parts of) the second leg of the journey. Both options will allow the user to travel to his destination without any significant delay. The first alternative is an already scheduled demand-responsive community bus stopping at the transportation hub at 7:35 a.m. and arriving at a stop near the user's workplace at 7:50, but necessitates a short walk to his final destination. The other alternative is a demand-responsive bus route custom-tailored to the user's needs by the demand-responsive transit service. It could arrive at the transportation hub at 7:45 a.m. and has a slightly higher traveling fee, but goes directly to the user's desired destination, arriving at 7:55 a.m. Because both options rank approximately equally according to the user's preferences, the recommendation service displays both options to the user via the transit application.

As the user fears oncoming rain, he chooses the option which stops directly at his destination. The recommendation service notifies the demand-responsive transit service about this decision, resulting in the scheduling of the new demand-responsive community bus trip. Simultaneously, the recommendation service asks the user for feedback on the transit recommendation which he gladly provides. This information is saved in the service data store to further improve the knowledge about the user's preferences and subsequently improve future recommendations.

At 7:45 am the user boards the demand-responsive community bus specifically scheduled for him, arriving at 7:55 am at his workplace, perfectly timed to participate in the working breakfast at the start of the meeting.

FIG. 5 shows a block diagram illustrating components of a computing device or system used in some implementations of techniques and systems providing intelligent recommendation of demand-responsive transit services as described herein. For example, any component of the system, including an intelligent recommendation service 130, movement/transit pattern and demand recognition service 140, demand-responsive transit system scheduling/info service 150, service data store 160, and an intelligent recommendation component 120 may be implemented as described with respect to device 1000. Device 1000 can itself include one or more computing devices. The hardware can be configured according to any suitable computer architectures such as Symmetric Multi-Processing (SMP) architecture or Non-Uniform Memory Access (NUMA) architecture.

The device 1000 can include a processing system 1001, which may include a processing device such as a central processing unit (CPU) or microprocessor and other circuitry that retrieves and executes software 1002 from storage system 1003. Processing system 1001 may be implemented within a single processing device but may also be distributed across multiple processing devices or sub-systems that cooperate in executing program instructions.

Examples of processing system 1001 include general purpose central processing units, application specific processors, and logic devices, as well as any other type of processing device, combinations, or variations thereof. The one or more processing devices may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof. In certain embodiments, one or more digital signal processors (DSPs) may be included as part of the computer hardware of the system in place of or in addition to a general purpose CPU.

Storage system 1003 may comprise any computer readable storage media readable by processing system 1001 and capable of storing software 1002 including, e.g., processing instructions for providing intelligent recommendation of demand-responsive transit services. Storage system 1003 may include volatile and nonvolatile, removable and non-removable media implemented in any method or technology for storage of information, such as computer readable instructions, data structures, program modules, or other data.

Examples of storage media include random access memory (RAM), read only memory (ROM), magnetic disks, optical disks, CDs, DVDs, flash memory, solid state memory, phase change memory, 3D-XPoint memory, or any other suitable storage media. Certain implementations may involve either or both virtual memory and non-virtual memory. In no case do storage media consist of a propagated signal. In addition to storage media, in some implementations, storage system 1003 may also include communication media over which software 1002 may be communicated internally or externally.

Storage system 1003 may be implemented as a single storage device but may also be implemented across multiple storage devices or sub-systems co-located or distributed relative to each other. Storage system 1003 may include additional elements capable of communicating with processing system 1001.

Software 1002 may be implemented in program instructions and, among other functions, may, when executed by device 1000 in general or processing system 1001 in particular, direct device 1000 or processing system 1001 to operate as described herein for providing intelligent recommendation of demand-responsive transit services. Software 1002 may provide program instructions 1004 that implement components for providing intelligent recommendation of demand-responsive transit services. Software 1002 may implement on device 1000 components, programs, agents, or layers that implement in machine-readable processing instructions 1004 the methods and techniques described herein.

In general, software 1002 may, when loaded into processing system 1001 and executed, transform device 1000 overall from a general-purpose computing system into a special-purpose computing system customized to provide intelligent recommendation of demand-responsive transit services in accordance with the techniques herein. Indeed, encoding software 1002 on storage system 1003 may transform the physical structure of storage system 1003. The specific transformation of the physical structure may depend on various factors in different implementations of this description. Examples of such factors may include, but are not limited to, the technology used to implement the storage media of storage system 1003 and whether the computer-storage media are characterized as primary or secondary storage. Software 1002 may also include firmware or some other form of machine-readable processing instructions executable by processing system 1001. Software 1002 may also include additional processes, programs, or components, such as operating system software and other application software.

Device 1000 may represent any computing system on which software 1002 may be staged and from where software 1002 may be distributed, transported, downloaded, or otherwise provided to yet another computing system for deployment and execution, or yet additional distribution. Device 1000 may also represent other computing systems that may form a necessary or optional part of an operating environment for the disclosed techniques and systems.

A communication interface 1005 may be included, providing communication connections and devices that allow for communication between device 1000 and other computing systems (not shown) over a communication network or collection of networks (not shown) or the air. Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned communication media, network, connections, and devices are well known and need not be discussed at length here.

It should be noted that many elements of device 1000 may be included in a system-on-a-chip (SoC) device. These elements may include, but are not limited to, the processing system 1001, a communications interface 1005, and even elements of the storage system 1003 and software 1002.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

It should be understood that the examples and embodiments described herein are for illustrative purposes only and that various modifications or changes in light thereof will be suggested to persons skilled in the art and are to be included within the spirit and purview of this application.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

All patents, patent applications, provisional applications, and publications referred to or cited herein (including those in the “References” section) are incorporated by reference in their entirety, including all figures and tables, to the extent they are not inconsistent with the explicit teachings of this specification.

What is claimed is:

1. A system for providing intelligent recommendation of demand-responsive transit services, comprising:
one or more computer readable media;
a processing system; and
program instructions for an intelligent recommendation service stored on the one or more computer readable storage media that, when executed by the processing system, direct the processing system to:
receive a current location of a transit user from a location detection component of a user device;
identify an imminent transit demand of the transit user by comparing historical transit-movement data about the transit user, stored in a service data store on the computer readable storage media, to the current location of the transit user;
search the service data store for prior-scheduled transit options meeting the imminent transit demand;
retrieve filtering parameters, comprising at least demand-responsive transit provider constraints and known user preferences, from the service data store;
retrieve possible demand-responsive transit options for meeting the imminent transit demand from a demand-responsive transit system scheduling/information service;
use the prior-scheduled transit options and the possible demand-responsive transit options to identify preferred transit alternatives in accordance with the filtering parameters; and
send the preferred transit alternatives and the imminent transit demand to the user device.

2. The system of claim 1, further comprising program instructions that, when executed by the processing system, direct the processing system to:
in response to receiving, from the user device, a positive indication that the user accepts one of the preferred transit alternatives and the positive indication includes one of the possible demand-responsive transit options, sending a transit scheduling request to the demand-responsive transit system scheduling/information service.

3. The system of claim 1, further comprising program instructions that, when executed by the processing system, direct the processing system to:
in response to receiving, from the user device, a positive indication that the user accepts one of the preferred transit alternatives:
providing input elements to the user device for receiving acceptance feedback from the user; and
receiving, from the user device, and storing, in a data structure of the service data store, a result of the positive indication and the acceptance feedback.

4. The system of claim 1, further comprising program instructions that, when executed by the processing system, direct the processing system to:
in response to receiving, from the user device, a negative indication that the user rejects all of the preferred transit alternatives:
providing input elements to the user device for receiving rejection feedback from the user; and
receiving, from the user device, and storing, in a data structure of the service data store, a result of the negative indication and the rejection feedback.

5. The system of claim 1, wherein the historical transit-movement data comprises a historical compilation of current locations of the user device.

6. The system of claim 1, wherein the historical transit-movement data comprises transit usage information from a transit application of the user device.

7. An apparatus comprising:
one or more computer readable storage media;
a processing system;
a location detection component; and
a transit application including an intelligent recommendation component, the application embodied in program instructions stored on the one or more computer readable storage media that, when executed by the processing system, direct the processing system to:
send, to an intelligent recommendation service, a current location from the location detection component, wherein the current location refers to an imminent transit demand;
receive, from the intelligent recommendation service, preferred transit alternatives and a determined imminent transit demand; and
surface a transit options view of the preferred transit alternatives and the determined imminent transit demand.

8. The apparatus of claim 7, further comprising program instructions that, when executed by the processing system, direct the processing system to:
in response to detecting, at the transit options view, a positive indication that a user accepts one of the preferred transit alternatives:
surfacing input elements on the transit options view for receiving acceptance feedback from the user; and
sending a result of the positive indication and the acceptance feedback to the intelligent recommendation service.

9. The apparatus of claim 7, further comprising program instructions that, when executed by the processing system, direct the processing system to:
in response to detecting, at the transit options view, a negative indication that a user rejects all of the preferred transit alternatives:
surfacing input elements on the transit options view for receiving rejection feedback from the user; and
sending a result of the negative indication and the rejection feedback to the intelligent recommendation service.

10. The apparatus of claim 7, wherein the location detection component comprises a GPS transceiver.

11. A method for providing intelligent recommendation of demand-responsive transit services, comprising:
receiving a current location of a transit user from a location detection component of a user device;
identifying an imminent transit demand of the transit user by comparing historical transit-movement data about the transit user to the current location of the transit user from the location detection component;
searching for prior-scheduled transit options meeting the imminent transit demand;
retrieving filtering parameters comprising at least demand-responsive transit provider constraints and known user preferences;
retrieving possible demand-responsive transit options for meeting the imminent transit demand;
using the prior-scheduled transit options and the possible demand-responsive transit options to identify preferred transit alternatives in accordance with the filtering parameters; and
sending the preferred transit alternatives and the imminent transit demand to the user device.

12. The method of claim 11, further comprising:
in response to receiving, from the user device, a positive indication that the user accepts one of the preferred transit alternatives and the positive indication includes one of the possible demand-responsive transit options, sending a transit scheduling request to a demand-responsive transit system.

13. The method of claim 11, further comprising:
in response to receiving, from the user device, a positive indication that the user accepts one of the preferred transit alternatives:
providing acceptance feedback parameters to the user device; and
receiving, from the user device, and storing, in a data structure of the service data store, a result of the positive indication and acceptance feedback.

14. The method of claim 11, further comprising:
in response to receiving, from the user device, a negative indication that the user rejects all of the preferred transit alternatives:
providing rejection feedback parameters to the user device; and
receiving, from the user device, and storing, in a data structure of the service data store, a result of the negative indication and rejection feedback.

15. The method of claim 11, wherein the historical transit-movement data comprises a historical compilation of current locations of the user device.

16. The method of claim 11, wherein the historical transit-movement data comprises transit usage information from a transit application of the user device.

17. The method of claim 11, wherein the imminent transit demand comprises a deviation from the transit user's typical transit behaviors.

18. The method of claim 17, wherein the deviation comprises a shifted start time or different starting location from the typical transit behaviors.
